(19) United States
(12) Patent Application Publication
(10) Pub. No.: US 2005/0282457 A1
(43) Pub. Date: Dec. 22, 2005

(54) Display face plate and its method of making

(75) Inventors: Shun-Yu Wang, Chunan (TW); Min-Tsung Hsiao, Chunan (TW)

Correspondence Address: C.P. Chang;c/o Pacific Law Group LLP, Suite 525, 224 Airport Parkway, San Jose, CA, 95110, US

(73) Assignee: Taiwan Micro Display Corp., Chunan (TW)

(21) Appl. No.: 10/871,477

(22) Filed: Jun. 18, 2004

(51) Int. Cl. H01J 9/38

(52) U.S. Cl. 445/9; 445/23

(57) ABSTRACT

A multi-layer image display faceplate and method of making is proposed for a micro-display or an LCD display. A layer of hard solid material is plated onto either a wafer or a glass base plate of an LCD faceplate array. The hard solid material is then coated with a photoresist and photolithographically etched into at least one parallel pair of inner dam and outer dam with the inner dam surrounding thus defining an interstitial volume and the dams forming an irrigation ditch in between. Next, either the glass base plate or the wafer is placed on top and the interstitial volume is filled with an effluent LCD material while the irrigation ditch is filled with a bonding effluent such as a resin. The resin then goes through a hardening treatment resulting in a desired multi-layer structure with an accurate gap height between the glass base plate and the wafer.

### BACKGROUND OF THE INVENTION

1. Field of the Invention

The present invention relates generally to the field of image display devices. More particularity, the present invention is directed to the border frame of a multi-layer image display faceplate and its method of making.

2. Description of the Related Art

Image display devices such as a micro-display device or a Liquid Crystal Display (LCD) panel are widely used in products such as an LCD image projector, a projection TV, a computer display or a display faceplate of a variety of electrical equipments. The underlying principle for the display function is based upon the image display capability of the LCD material. As such, the structural design and associated manufacturing process for these micro-display devices and LCD panels, generally called LCD display faceplates, will directly affect the product quality.

During a traditional manufacturing process of these LCD display faceplates, a wafer is matched with a matrix array glass faceplate, with an LCD layer sandwiched in between, to batch fabricate a multitude of LCD display faceplate units. The wafer has a matrix array corresponding to that of the glass faceplate and each unit of the wafer matrix array has a fabricated driving circuitry, typically with an integrated circuit (IC) process, on it for driving the LCD layer to effect an image display. Therefore, during the bonding process of these LCD display faceplates prior to the filling of the effluent LCD material into each display unit, the border frame of each display unit must be delineated to facilitate bonding, LCD material filling and subsequent dicing into individual display units.

FIG. 1A and FIG. 1B are the top view and the corresponding cross sectional structure of a prior art display faceplate A for a single display unit. The display faceplate A has a bordering spacer frame C on top of a wafer B. A glass plate C1 is the cover of the display faceplate A thus defining an interstitial volume F with a gap height G. The formation process of the spacer frame C starts with a routed dispensing of a controlled amount of bonding effluent with an automatic glue-dispensing machine following the route of the spacer frame C. The bonding effluent can be, for example, an epoxy resin or a UV-curable resin for bonding the subsequently overlaid glass plate C1. The glass plate C1 is then placed upon the assembly. A top laminate plate D and a bottom laminate plate E can be bonded to the assembly. Next, the bonding effluent is hardened with a hardening treatment forming the spacer frame C. The interstitial volume F is then filled with a liquid crystal effluent H to complete the cross sectional structure as shown. The above prior art display face plate structure and its associated method of formation have the following disadvantages:
(1) It is not easy to control and accurately position the spacer frame C during the routed dispensing of the bonding effluent. The bonding effluent has a propensity of migrating into either the interstitial volume F or the kerf area of the single display unit causing a yield loss.
(2) As the bonding effluent is not yet hardened while the top laminate plate D and the bottom laminate plate E are being bonded to the assembly, only a limited amount of pressure can be exerted in between. Consequently, the accuracy of the gap height G can not be effectively controlled and this in turn causes a difficulty of controlling the bonding quality of the glass plate C1.
(3) While attempt has been made in the past to improve the above disadvantages by dispersing spacing particles into the bonding effluent so as to improve the accuracy of the gap height G, it was still difficult to handle problems caused by the viscosity variation of the bonding effluent. For example, a high viscosity would cause difficulty and/or non-uniformity of spacing particle dispersion. On the other hand, a very low viscosity would cause the spacing particles to either stay afloat the top of or settle to the bottom of the bonding effluent and, in either case, would disable their ability to accurately control the gap height G. Additionally, a mixer equipment needs to be added for the dispersion thus increasing the manufacturing cost.
(4) As the bonding effluent, being the constituent of the spacer frame C, comes in direct contact with the liquid crystal effluent H during its filling into the interstitial volume F, rigorous material compatibility criteria must be met for the selection of the liquid crystal effluent and the resins causing additional burden on manufacturability.

In view of the above disadvantages, it is therefore desirable to devise an improved border frame structure of the multi-layer image display faceplate together with its method of manufacturing.

### SUMMARY OF THE INVENTION

A multi-layer image display faceplate and its method of making is proposed. Expressed within an x-y-z coordinate, the display faceplate has successive bonded layers L₁, L₂, . . . , Lⱼ, . . . , L_{N} lying in the x-y plane with at least two successive layers Lₖ and Lₖ₊₁ separated by a gap height G_{K} that, together with a number of spatial sub-zones Zₖ₁, Zₖ₂, . . . , Zₖₘ, . . . , Z_{kP} within Lₖ and Lₖ₊₁, form a corresponding number of interstitial volumes ISₖ₁, ISₖ₂, . . . , ISₖₘ, . . . , ISₖₚ each of which must be filled with an effluent LCD material for display. Within G_{K} and for each ISₖₘ, the display faceplate comprises:
(a) At least one inner dam IDₖₘ bridging Lₖ and Lₖ₊₁ and surrounding thus defining ISₖₘ.

(b) One or more outer dams ODₖ₁, ODₖ₂, . . . , ODₖₙ, . . . , OD_{kQ} located successively away from ISₖₘ and IDₖₘ, where each ODₖₘ, forms a wall with a height in the z-direction thus defining a corresponding number of irrigation ditches IRDₖ₁, IRDₖ₂, . . . , IRDₖₙ, . . . , IR_{DkQ}.

Hence, together with Lₖ and Lₖ₊₁, the IDₖₘ enables the filling of the effluent LCD material and the ODₖ₁, ODₖ₂, . . . , ODₖₙ, . . . , OD_{kQ} enable the filling of bonding effluents for bonding Lₖ and Lₖ₊₁ with an accurate gap height G_{K}.

The outer dams can be routed, in the x-y plane, substantially parallel to the inner dam forming a uniform cross section along the corresponding irrigation ditches.

Due to the presence of the inner dam and outer dams, there is no need of spacing particles embedded within the bonding effluents while still maintaining the accurate gap height G_{K}.

Due to the presence of the inner dam IDₖₘ, the effluent LCD material and the bonding effluents can be independently selected as they are prevented from contacting each other by the inner dam.

The inner dam IDₖₘ has at least one opening for the entry of the effluent LCD material during its filling into ISₖₘ. Similarly, each outer dam ODₖₙ has at least one opening for the entry of bonding effluents into the irrigation ditch IRDₖₙ. Additionally, each ODₖₙ can have more opening for the exit of bonding effluents during their filling process.

Within some interstitial volume ISₖₘ but near the inner dam opening, a damping wall can be disposed that runs transverse to the effluent flow during its filling process. The damping wall effects a more even and slower effluent LCD material injection into ISₖₘ. The damping wall can be made to bridge Lₖ and Lₖ₊₁ hence further strengthening the support of the gap height G_{K} and improving its dimensional accuracy.

An embodiment of the invention includes the layer Lₖ being a wafer, the layer Lₖ₊₁ being a glass plate, the inner dam and outer dams being a hard solid material such as a metal alloy or polysilicon, the effluent material being a liquid crystal and the bonding effluent being epoxy resin or UV-curable resin.

The method of making the portion of bonded layers Lₖ and Lₖ₊₁ for each interstitial volume ISₖₘ of the multi-layer image display faceplate includes:
(a) Forming, atop the layer Lₖ, at least one inner dam IDₖₘ and the outer dams ODₖ₁, ODₖ₂, . . . , ODₖₙ, . . . , OD_{kQ} with the wall height of the inner dam essentially equal to the gap height G_{K}.

(b) Placing the layer Lₖ₊₁ atop the processed layer Lₖ thus forming the interstitial volume ISₖₘ and covering the irrigation ditches IRDₖ₁, IRDₖ₂, . . . , IRDₖₙ, . . . , IRD_{kQ}.
(c) Filling the ISₖₘ with the effluent LCD material and filling the IRDₖ₁, IRDₖ₂, . . . , IRDₖₙ, . . . , IRD_{kQ} with the bonding effluents to complete the portion of bonded layers Lₖ and Lₖ₊₁.

Where the damping wall is desired, step (a) of the above method can include a simultaneous formation of the damping wall as well.

Forming the inner dam and the outer dams can be accomplished by plating the hard solid material atop the layer Lₖ followed by patterning the plated hard solid material with a photolithographic process where the plated hard solid material is etched according to a pre-determined geometry of the inner and outer dams.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawing, in which like reference characters designate the same or similar parts throughout the several views, and wherein:

FIG. 1A-B are the top view and the corresponding sectional structure of a prior art display faceplate;

FIG. 2A illustrates the cross sectional structure of an embodiment of the present invention single display faceplate;

FIG. 2B is the top view of the structure of an embodiment of the present invention single display face plate;

FIG. 3 is an embodiment of the present invention method of making a portion of a multi-layer display faceplate;

FIG. 4A is a cross section illustrating a step of the present invention method wherein a hard solid layer is plated onto a wafer;

FIG. 4B is a cross section illustrating a step of the present invention method wherein a photo-resist layer is coated onto the hard solid layer;

FIG. 4C is a cross section illustrating a step of the present invention method wherein the photo-resist layer is being photolithographic patterned by exposure through a photo mask;

FIG. 4D is a cross section illustrating a step of the present invention method wherein the photo-resist layer is being photolithographic patterned by etching through an exposed portion of the photo mask;

FIG. 4E is a cross section illustrating a step of the present invention method wherein a removal region of the hard solid layer is etched away through an etched opening of the photo mask;

FIG. 4F is a cross section illustrating a step of the present invention method an inner dam, an outer dam together with an irrigation ditch are finally formed after the removal of the residual photo mask;

FIG. 5 is a cross section illustrating an alternative step of the present invention method wherein a hard solid layer is plated onto a glass plate; and

FIG. 6 is the top view of the structure of another embodiment of the present invention single display faceplate.

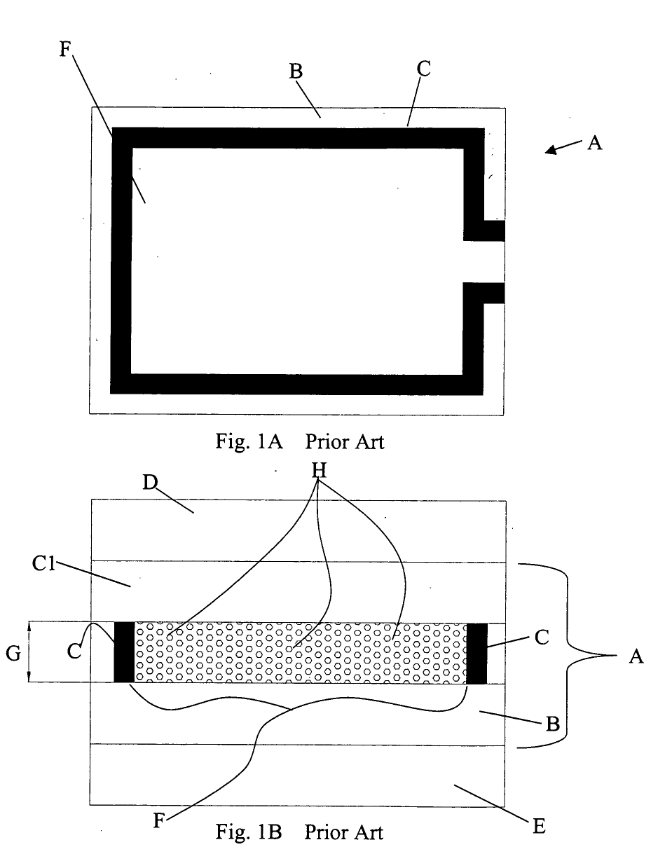

### DETAILED DESCRIPTION OF THE PREFERRED EMBODIMENTS

In the following detailed description of the present invention, numerous specific details are set forth in order to provide a thorough understanding of the present invention. However, it will become obvious to those skilled in the art that the present invention may be practiced without these specific details. In other instances, well-known methods, procedures, materials, components and circuitry have not been described in detail to avoid unnecessary obscuring aspects of the present invention. The detailed description is presented largely in terms of simplified orthogonal views. These descriptions and representations are the means used by those experienced or skilled in the art to concisely and most effectively convey the substance of their work to others skilled in the art.

Reference herein to “one embodiment” or an “embodiment” means that a particular feature, structure, or characteristics described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of process flow representing one or more embodiments of the invention do not inherently indicate any particular order nor imply any limitations of the invention.

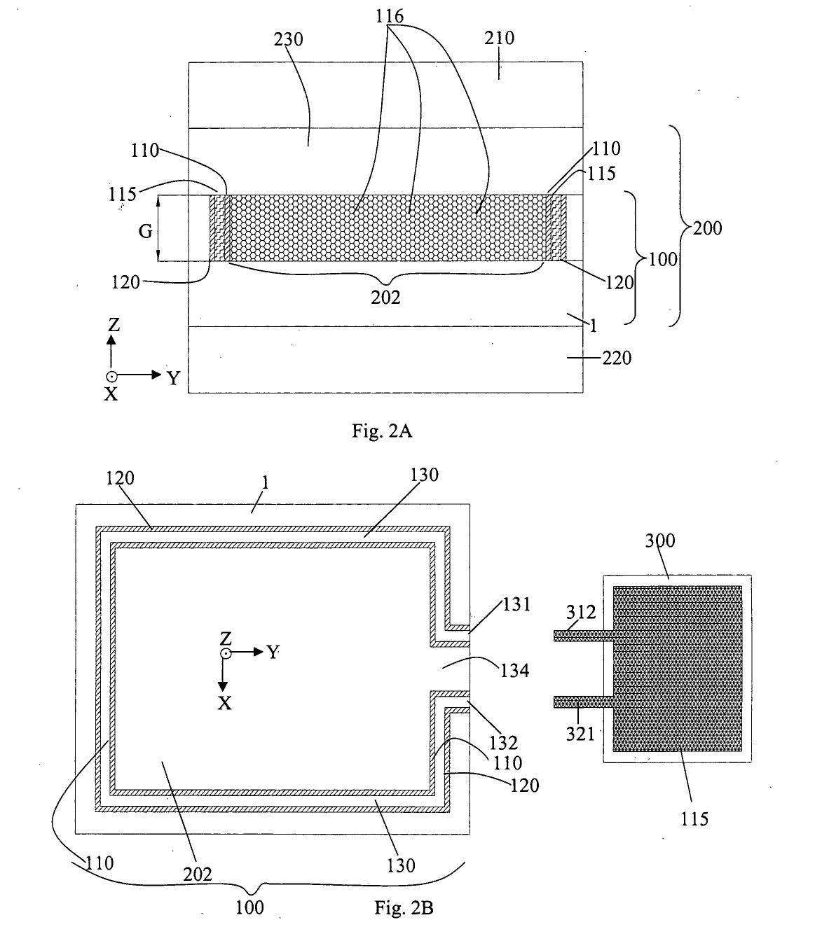

FIG. 2A and FIG. 2B illustrate the cross sectional structure and top view of an embodiment of the present invention single display faceplate 200. A wafer with a border frame 100 forms part of the single display faceplate 200. A method of making the wafer with a border frame 100 will be presently described. The wafer with a border frame 100 has a wafer 1 supporting a pair of inner dam 110 and outer dam 120 running essentially parallel to each other within the x-y plane and generally along the border of the wafer 1 hence defining, together with an upper glass plate 230, an interstitial volume 202 and a irrigation ditch 130. The irrigation ditch 130 functions to fill and hold a resin 115. The inner dam 110, together with the outer dam 120, has an opening 134 along one edge of the wafer 1 for the entry of the effluent liquid crystal 116 during its filling into the interstitial volume 202. Likewise, the irrigation ditch 130 forms two inlets 131 and 132 along one edge of the wafer 1.

As a manufacturing provision, the two inlets 131 and 132 are respectively mated with two glue-injecting pipings 312 and 321 of an externally attached frame glue injector 300 filled with the resin 115 for filling the irrigation ditch 130 with resin 115. While not illustrated here, a configurational variation can provide more openings along the outer dam 120 and use some or all of these openings for the exit of the resin 115 during its filling into the irrigation ditch 130. After the irrigation ditch 130 gets filled with the resin 115, a laminating and bonding process, using a bonding press that is not shown here, follows that bonds an upper bonding plate 210 to the wafer with a border frame 100 through the glass plate 230 and bonds a lower bonding plate 220 beneath the wafer 1. Notice that the glass plate 230 is bonded to the wafer with a border frame 100 with the resin 115. Additionally, owing to the support of the inner dam 110 and the outer dam 120, being both made of a hard solid material, higher pressure can be exerted here between the upper bonding plate 210 and the lower bonding plate 220 thus effecting a positive, accurate fixation of the glass plate 230 onto the top of the wafer with a border frame 100. Consequently, the accuracy of the gap height G is effectively defined and controlled by the height of the inner and outer dams 110 and 120 and the bonding quality of the glass plate 230 is also insured. Clearly this is now accomplished without dispersing any spacing particles into the resin 115 thus significantly saving an associated manufacturing and equipment cost. One other advantage is that, owing to the presence of the inner and outer dams 110 and 120, the material selection for the liquid crystal 116 and the resin 115 are made independent of each other as they are prevented from contacting each other. By the same token, the resin 115 is now positively prevented from migrating into either the interstitial volume 202 or the kerf area of the single display faceplate 200 saving a yield loss. For those skilled in the art, the proposed structure and manufacturing method for the wafer with a border frame 100 as applied to the single display faceplate 200 can be effectively used for a transmission-type micro-display, a reflection-type micro-display or an LCD display with similar advantages.

Following the completion of the laminating and bonding process, the filled resin 115 can be hardened with, for example, a baking process or an Ultra Violet (UV) radiation. The interstitial volume 202 can then be filled with a liquid crystal 116 through the opening 134. The opening 134 is then sealed, although not shown here, to complete the single display faceplate 200.

By now it should become clear that more than one interstitial volume just like the interstitial volume 202 can be incorporated in the single display faceplate 200. It should also be clear that more upper plates in addition to the upper bonding plate 210 and more lower plates in addition to the lower bonding plate 220 can be bonded to the single display faceplate 200 to form a more complex multi-layer display faceplate. Furthermore, these additional upper plates or lower plates can themselves have a structure just the single display faceplate 200 of the present invention. Therefore, in general, the present invention proposes a multi-layer display faceplate for displaying images having a number of successive bonded layers L₁, L₂, . . . , Lⱼ, . . . , L_{N} generally lying in the x-y plane, where N>=2 and wherein at least two successive layers Lₖ and Lₖ₊₁, where 1=<k<N, are separated along the z-direction with a gap height G_{K}. The gap height G_{K}, together with each of a number of spatial sub-zones Zₖ₁, Zₖ₂, . . . , Zₖₘ, . . . , Z_{kP} within the layers Lₖ and Lₖ₊₁ and generally lying in the x-y plane, form a corresponding number of interstitial volumes ISₖ₁, ISₖ₂, . . . , ISₖₘ, . . . , ISₖₚ each of which must be filled with an effluent material to effect a display function. The display faceplate includes, within the gap height G_{K} and for each interstitial volume ISₖₘ:
(1) At least one inner dam IDₖₘ in the form of a wall bridging the layers Lₖ and Lₖ₊₁ and surrounding thus defining the interstitial volume ISₖₘ.
(2) At least one outer dams ODₖ₁, ODₖ₂, . . . , ODₖₙ, . . . , OD_{kQ} located successively away from the interstitial volume ISₖₘ and the inner dam IDₖₘ, where Q>=1, each in the form of a wall with a height in the z-direction thus defining a corresponding number of irrigation ditches IRDₖ₁, IRDₖ₂, . . . , IRDₖₙ, . . . , IRD_{kQ}.

The inner dam IDₖₘ, together with the layers Lₖ and Lₖ₊₁, enables the filling of the effluent material and the outer dams ODₖ₁, ODₖ₂, . . . , ODₖₙ, . . . , OD_{kQ} enable the filling of bonding effluents for bonding the two layers Lₖ and Lₖ₊₁ with an accurate gap height G_{K}.

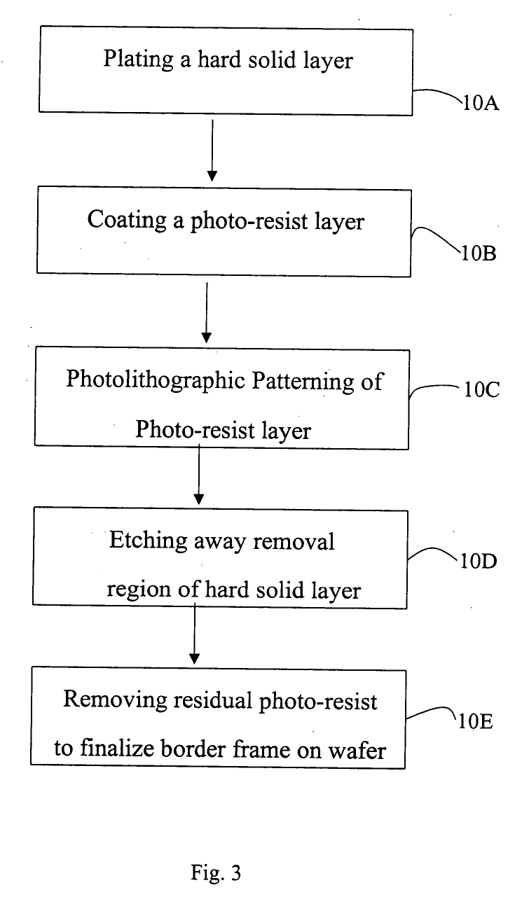

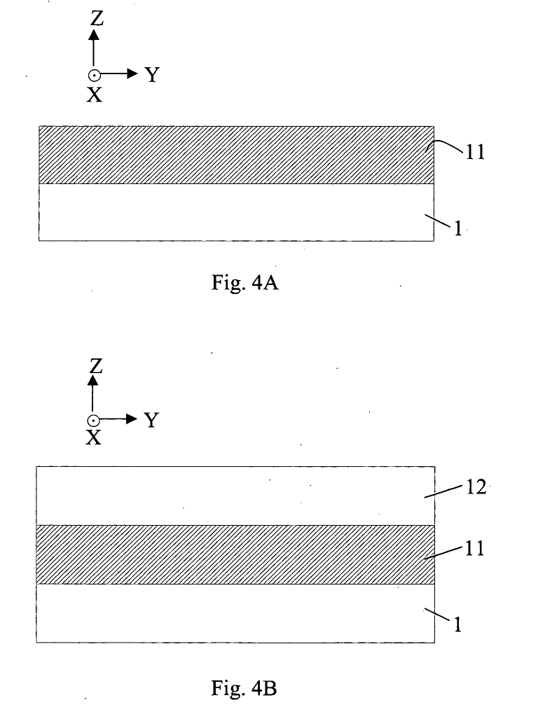

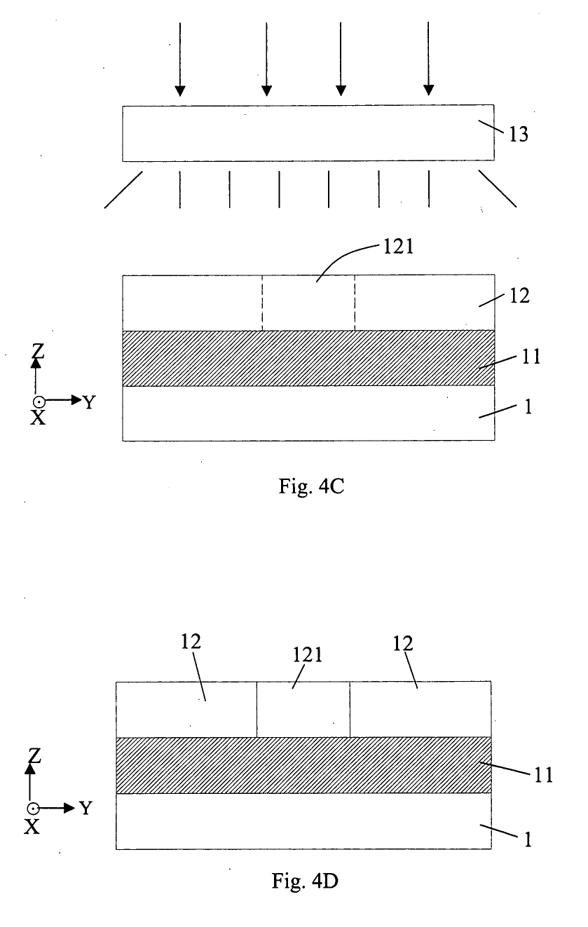

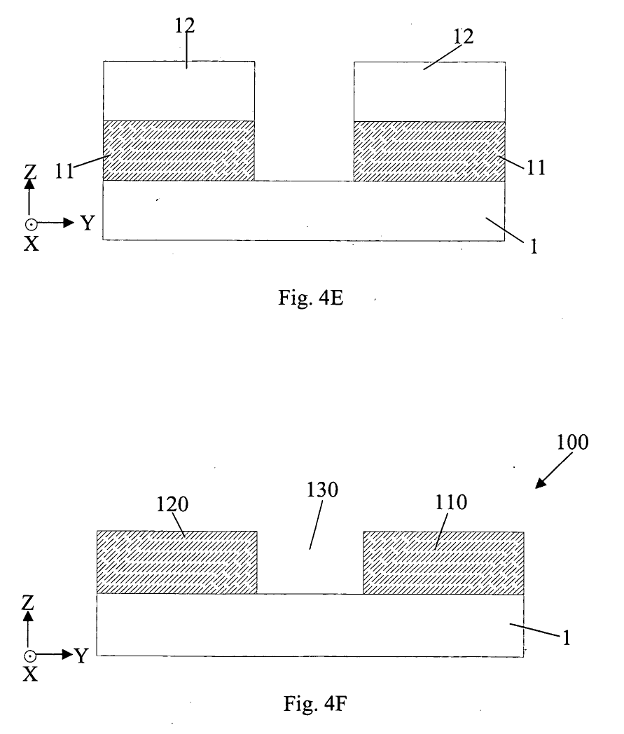

Referring jointly to FIG. 3, FIG. 4A, FIG. 4B, FIG. 4C, FIG. 4D, FIG. 4E and FIG. 4F, the method of making the multi-layer display faceplate according to the present invention is illustrated. FIG. 3 is an embodiment of the present invention method of making the wafer with a border frame 100 that is a portion of a multi-layer display faceplate, in the form of a flow chart with steps 10A through 10E. More specifically:

The step plating a hard solid layer 10A is graphically illustrated in FIG. 4A wherein a hard solid layer 11 is plated on top of a wafer 1. The material for the hard solid layer 11 can be a polysilicon, a metal or an alloy of Aluminum, Copper or Tungsten, etc.

The step coating a photo-resist layer 10B is graphically illustrated in FIG. 4B wherein a photo-resist layer 12 is coated on top of the hard solid layer 11.

The step photolithographic patterning of photo-resist layer 10C is graphically illustrated in FIG. 4C wherein the composite of wafer 1, hard solid layer 11 and photo-resist layer 12 from FIG. 4B is exposed through a photo mask 13 to sensitize a pre-defined removal region of photo-resist layer 121. The removal region of photo-resist layer 121 is then etched away, as illustrated in FIG. 4D, to expose a corresponding surface of the hard solid layer 11.

The step etching away removal region of hard solid layer 10D is graphically illustrated in FIG. 4E wherein the exposed region of the hard solid layer 11 corresponding to the removal region of photo-resist layer 121 is likewise etched away.

The step removing residual photo-resist to finalize border frame on wafer 1 is graphically illustrated in FIG. 4F wherein the residual photo-resist layer 12 covering the hard solid layer 11 from FIG. 4E is again removed with a process similar to the step photolithographic patterning of photo-resist layer 12. The resulting composite is a wafer with a border frame 100 of the present invention. As illustrated in FIG. 4F, the thus-formed wafer with a border frame 100 includes at least one pair of inner dam 110 and outer dam 120 defining a corresponding irrigation ditch 130 running substantially in the x-direction in this case. The routing of the outer dam 120 in the x-y plane can be, via a corresponding pattern design of the photo-resist layer 12, made substantially parallel to that of the inner dam 110 although this does not have to be the case. Furthermore, depending upon the specific design of the photo mask 13, more than one inner dam and more than one outer dam, located successively away from the interstitial volume 202 and the inner dams can certainly be created to suit additional needs with additional advantages.

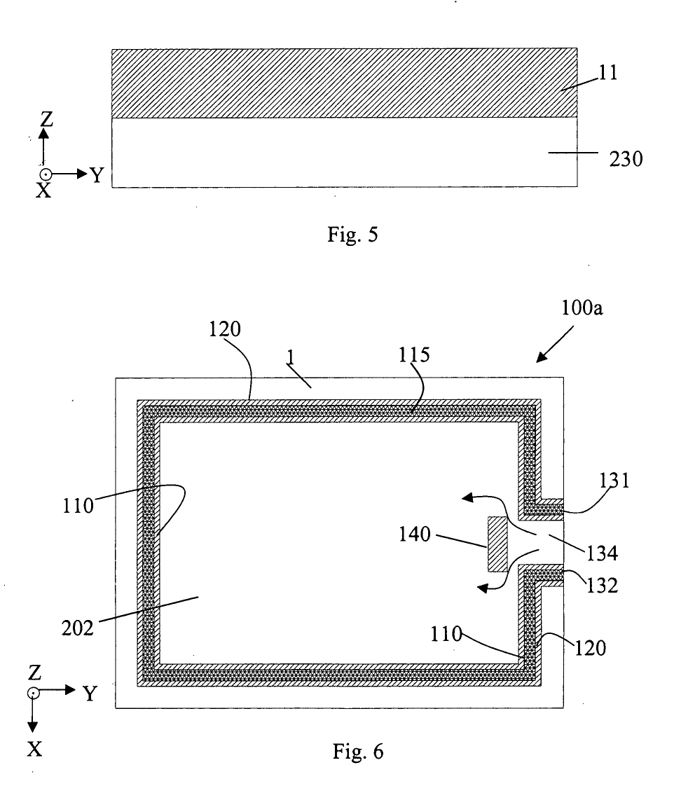

As another embodiment of the present invention, FIG. 5 is a cross section illustrating a variation of the present invention method wherein, instead of the previously illustrated step 10A of plating the hard solid layer 11 onto the wafer 1, the hard solid layer 11 is plated onto the glass plate 230 with the rest of the steps 10B through 10E similar to before with only minor variations for making the wafer with a border frame 100 that is a portion of a multi-layer display faceplate with similar advantages.

Yet another embodiment of the present invention single display faceplate 200 is illustrated in FIG. 6 that is a top view of a wafer with a border frame and damping wall 100a. Within the interstitial volume 202 but near the opening 134 of the inner dam 110, a damping wall 140 is disposed that runs generally transverse to the flow direction of the liquid crystal 116 during its filling process. Thus, during the filling process the damping wall 140 acts to slow down the flow rate and to divide the main flow into sub-flows for a more even and slower LCD effluent injection into the interstitial volume 202 hence avoiding an excessive flow rate that might carry undesirable impurities into the interstitial volume 202. In addition, the height of the damping wall 140, along the z-direction, can be made to bridge the wafer 1 and the glass plate 230 hence further strengthening the support of the gap height G and improving its dimensional accuracy.

As illustrated with numerous exemplary embodiments, a multi-layer image display faceplate and its method of making is proposed. However, for those skilled in this field, these exemplary embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

1. A multi-layer image display faceplate, expressed with x-y-z Cartesiancoordinates, comprising:
(a) at least two successive bonded layers L₁, L₂, . . . , Lⱼ, . . . , L_{N} generally lying in the x-y plane, wherein at least two layers Lₖ and Lₖ₊₁ are separated along the z-direction with a pre-determined gap height G_{K};
(b) at least one pre-determined spatial sub-zones Zₖ₁, Zₖ₂, . . . , Zₖₘ, . . . , Z_{kP} within the layers Lₖ and Lₖ₊₁ and generally lying in the x-y plane to form a corresponding number of interstitial volumes ISₖ₁, ISₖ₂, . . . , ISₖₘ, . . . , ISₖₚ;
(c) at least one inner dam IDₖₘ in the form of a wall bridging the layers Lₖ and Lₖ₊₁ and surrounding thus defining said interstitial volume ISₖₘ for the filing of an effluent material; and
(d) at least one outer dams ODₖ₁, ODₖ₂, . . . , ODₖₙ, . . . , OD_{kQ} located successively away from said interstitial volume ISₖₙₘ and said at least one inner dam IDₖₘ, each said outer dam is in a form of a wall with a height in the z-direction thus defining a corresponding number of irrigation ditches IRDₖ₁, IRDₖ₂, . . . , IRDₖₙ, . . . , IRD_{kQ} for the filling of one or more bonding effluents for bonding said Lₖ and Lₖ₊₁ accurately within said gap height G_{K}.

2. The display faceplate of claim 1 wherein said bonding effluents are free of spacing particles while still maintaining said accurate gap height G_{K}.

3. The display faceplate of claim 1 wherein the effluent material and the bonding effluents are made independent of each other as they are prevented from contacting each other.

4. The display faceplate of claim 1 wherein the routing in the x-y plane of said outer dams are substantially parallel to that of said at least one inner dam.

5. The display faceplate of claim 1 wherein said inner dam IDₖₘ has at least one inner dam opening for the entry of said effluent material during its filling into said interstitial volume ISₖₘ.

6. The display faceplate of claim 5 further comprises, within one or more selected interstitial volume ISₖₘ but near said inner dam opening, a damping wall running generally transverse to the direction of an effluent flow for more evenly and more slowly injecting said effluent material into said interstitial volume ISₖₘ.

7. The display faceplate of claim 6 wherein said damping wall bridges the layers Lₖ and Lₖ₊₁ hence further strengthening the support of said gap height G_{K} and improving its dimensional accuracy.

8. The display faceplate of claim 1 wherein each said outer dam ODₖₙ has at least one outer dam opening for the entry of said bonding effluents into said irrigation ditch IRDₖₙ.

9. The display faceplate of claim 8 wherein each said outer dam ODₖₙ has at least one more outer dam opening for the exit of said bonding effluents during their filling into said irrigation ditch IRDₖₙ.

10. The display faceplate of claim 1 wherein said layer Lₖ is a wafer, said layer Lₖ₊₁ is a glass plate and said effluent material is a liquid crystal.

11. The display faceplate of claim 1 wherein said at least one inner dam IDₖₘ and said outer dams ODₖ₁, ODₖ₂, . . . , ODₖₙ, . . . , OD_{kQ} are made of a hard solid material.

12. The display faceplate of claim 11 wherein said hard solid material is metal, metal alloy or polysilicon.

13. The display faceplate of claim 12 wherein the metal alloy are selected from the group consisting of Aluminum, Copper and Tungsten.

14. The display faceplate of claim 1 wherein said bonding effluent is epoxy resin or UV-curable resin.

15. A method of making a portion of multi-layer display faceplate having, expressed with x-y-z Cartesian coordinates, at least two successive bonded layers L₁, L₂, . . . , Lⱼ, . . . , L_{N} generally lying in the x-y plane, wherein at least two layers Lₖ and Lₖ₊₁ are separated along the z-direction with a pre-determined gap height G_{K} that, together with each of at least one pre-determined spatial sub-zones Zₖ₁, Zₖ₂, . . . , Zₖₘ, . . . , Z_{kP} within the layers Lₖ and Lₖ₊₁ and generally lying in the x-y plane, form a corresponding number of interstitial volumes ISₖ₁, ISₖ₂, . . . , ISₖₘ, . . . , ISₖₚ each of which must be filled with an effluent material to effect a display function, the method of making the portion of bonded layers Lₖ and Lₖ₊₁ for each interstitial volume ISₖₘ comprises:
(a) providing the layer Lₖ;
(b) forming, atop the layer Lₖ, at least one inner dam IDₖₘ and at least one outer dams ODₖ₁, ODₖ₂, . . . , ODₖₙ, . . . , OD_{kQ} with the at least one inner dam in the form of a wall with a wall height essentially equal to said gap height G_{K} and surrounding said interstitial volume ISₖₘ and with the outer dams located successively away from said interstitial volume ISₖₘ and the at least one inner dam, each outer dam in the form of a wall with a height in the z-direction thus defining a corresponding number of irrigation ditches IRDₖ₁, IRDₖ₂, . . . , IRDₖₙ, . . . , IRD_{kQ};
(c) placing the layer Lₖ₊₁ atop the hereto processed layer Lₖ thus forming said interstitial volume ISₖₘ and covering said irrigation ditches IRDₖ₁, IRDₖ₂, . . . , IRDₖₙ, . . . , IRD_{kQ}; and
(d) filling said ISₖₘ with said effluent material and filling said IRDₖ₁, IRDₖ₂, . . . , IRDₖₙ, . . . , IRD_{kQ} with one or more bonding effluents to complete the portion of bonded layers Lₖ and Lₖ₊₁.

16. The method of claim 15 further comprises choosing the bonding effluents to be free of spacing particles for filling said IRDₖ₁, IRDₖ₂, . . . , IRDₖₙ, . . . , IRD_{kQ} while still maintaining an accurate said gap height G_{K}.

17. The method of claim 15 further comprises a step of selecting materials independently for the effluent material and the bonding effluents before their respective filling.

18. The method of claim 15 further comprises routing, in the x-y plane, said outer dams to be substantially parallel to that of said at least one inner dam.

19. The method of claim 15 further comprises providing at least one inner dam opening along said inner dam IDₖₘ for the entry of said effluent material during its filling into said ISₖₘ.

20. The method of claim 19 further comprises providing, within one or more selected interstitial volume ISₖₘ but near said inner dam opening, a damping wall running generally transverse to the direction of an effluent flow during its filling process, for more evenly and more slowly injecting said effluent material into said interstitial volume ISₖₘ.

21. The method of claim 20 further comprises making said damping wall as a bridge the layers Lₖ and Lₖ₊₁ hence further strengthening the support of said gap height G_{K} and improving its dimensional accuracy.

22. The method of claim 15 further comprises providing at least one outer dam opening along each said outer dam ODₖₙ for the entry of said bonding effluents during their filling into said irrigation ditch IRDₖₙ.

23. The method of claim 22 further comprises providing at least one more outer dam opening along each said outer dam ODₖₙ for the exit of said bonding effluents during their filling into said irrigation ditch IRDₖₙ.

24. The method of claim 15 wherein forming said at least one inner dam and one or more outer dams further comprises plating a hard solid material atop the layer Lₖ followed by patterning the plated hard solid material.

25. The method of claim 24 wherein patterning the plated hard solid material further comprises photolithographically etching the plated hard solid material according to a pre-determined geometry of said at least one inner dam and one or more outer dams.
